(19) United States
(12) Patent Application Publication
(10) Pub. No.: US 2025/0198799 A1
(43) Pub. Date: Jun. 19, 2025

(54) DISPLAY TECHNOLOGIES

(71) Applicant: The Charles Stark Draper Laboratory, Inc., Cambridge, MA (US)

(72) Inventors: Kevin Duda, Cambridge, MA (US); Tristan Endsley, Cambridge, MA (US); Sherrie Holder, Cambridge, MA (US); Robyn Bernstein, Cambridge, MA (US); Ed Bergmann, Cambridge, MA (US); Jordan Dixon, Cambridge, MA (US); Matthew Stoeckle, Cambridge, MA (US); Juilanne Jensen, Cambridge, MA (US)

(21) Appl. No.: 18/983,775

(22) Filed: Dec. 17, 2024

Related U.S. Application Data
(60) Provisional application No. 63/611,463, filed on Dec. 18, 2023.
(60) Provisional application No. 63/625,110, filed on Jan. 25, 2024.

(51) Int. Cl. G01C 23/00; B64D 43/00

(52) U.S. Cl. CPC G01C 23/005; B64D 43/00

(57) ABSTRACT

A display system for a vehicle may include a display configured to present a dynamic horizontal situation display, a processor programmed to receive vehicle data from at least one vehicle sensor, the vehicle data indicating at least one of roll, pitch, and yaw of the vehicle, present, via the display, at least one ownship cue symbol overlaid on the horizontal situation display, and dynamically update the at least one ownship cue symbol based on at least one of the roll, pitch, and yaw of the vehicle based on the vehicle data to provide visual aids regarding the roll, pitch, and yaw to a pilot.

### CROSS-REFERENCE TO RELATED APPLICATIONS

This application claims priority under 35 U.S.C 119 (e) to U.S. Provisional Application No. 63/611,463 filed Dec. 18, 2023, and to U.S. Provisional Application No. 63/625,110 filed Jan. 25, 2024, which are incorporated by referenced herein in their entirety.

### TECHNICAL FIELD

In at least one aspect, the present inventions are related to display technologies for vehicles.

### BACKGROUND

Display technologies for vehicles, including airborne vehicles, present information to drivers and pilots. Such information may be cumbersome and efficient and easy to understand displays are often desired.

### SUMMARY

A display system for a vehicle may include a display configured to present a dynamic horizontal situation display, a processor programmed to receive vehicle data from at least one vehicle sensor, the vehicle data indicating at least one of roll, pitch, and yaw of the vehicle, present, via the display, at least one ownship cue symbol overlaid on the horizontal situation display, and dynamically update the at least one ownship cue symbol based on at least one of the roll, pitch, and yaw of the vehicle based on the vehicle data to provide visual aids regarding the roll, pitch, and yaw to a pilot.

A display system for a vehicle may include a display configured to present a dynamic aviation display, at least one user interface configured to receive pilot commands, a processor programmed to receive at least one command from the user interface, determine if a second and subsequent same command was received, and update the display to visually indicate a pulse sequence in response to receiving a second same command.

A method for generating a display for a vehicle may include receiving vehicle data from at least one vehicle sensor, the vehicle data indicating at least one of roll, pitch, and yaw of the vehicle, present, via a display, at least one ownship cue symbol overlaid on the horizontal situation display, and dynamically update the at least one ownship cue symbol based on at least one of the roll, pitch, and yaw of the vehicle based on the vehicle data to provide visual aids regarding the roll, pitch, and yaw to a pilot.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a block diagram of an example vehicle system, including a display system.

FIG. 2 illustrates an example Primary Flight Display (PFD) for lunar decent.

FIG. 3 illustrates an example Horizontal Situation Display (HSD).

FIG. 4 illustrates an example Hazard Map (HM) Display.

FIG. 5 illustrates an example Head-up Guidance Display (HUD).

FIG. 6 illustrates an example Vertical Navigation Situation Display (VNAV).

FIG. 7 illustrates an example Primary Flight Display (PFD) for RPOD.

FIG. 8 illustrates an example Horizontal Navigation Situation Display (HNAV).

FIG. 9 is another example HUD.

FIG. 10 is another example Vertical VNAV.

FIG. 11 is another example of a PFD for RPOD.

FIG. 12 is another example HNAV.

FIGS. 13A and 13B illustrate an example chart of example landing components.

FIGS. 14A, 14B and 14C illustrate an example chart of example components specific to the PFD, similar to the example shown in FIG. 2.

FIGS. 15A, 15B, 15C and 15D illustrate an example chart of example components specific to the Horizontal Situation Display (HSD), similar to the example shown in FIG. 3.

FIGS. 16A and 16B illustrate an example chart of example components specific to the Hazard map, similar to the example shown in FIG. 4.

FIG. 17 illustrates an example chart of example RPOD components.

FIG. 18A illustrates an example Far Rendezvous for HUD.

FIG. 18B illustrates proximity operations for HUD.

FIGS. 19A and 19B illustrate an example chart of example HUD components.

FIG. 20A illustrates an example Far Rendezvous for VNAV

FIG. 20B illustrates proximity operations for VNAV.

FIGS. 21A and 21B illustrate an example chart of example VNAV components.

FIG. 22A illustrates an example PFD for RPOD Far Rendezvous.

FIG. 22B illustrates an example PFD for RPOD proximity operations.

FIGS. 23A and 23B illustrate an example chart of example RPOD PFD components.

FIG. 24A illustrates Far Rendezvous Horizontal Navigation Situation Displays (HNAV).

FIG. 24B illustrates proximity operations for HNAV.

FIGS. 25A and 25B illustrate an example chart of example HNAV components.

FIG. 26 illustrates an example docking grid with distinctive target overlay that is currently being explored for the Rendezvous, Proximity Operations, and Docking (RPOD) heads-up display (HUD).

FIGS. 27A, 27B, and 27C illustrate an example chart of example Bergmann Predictive cues and components.

FIG. 28 illustrates an example display having a trajectory warming arc cue 228 for the Horizontal Situation Display (HSD).

FIG. 29 illustrates an example ownship cue symbol having a plurality of legs, creating a reference frame for front, left, back and right.

FIG. 30A illustrates an example cue symbol where the window symbol is in line with the horizon and the vehicle has no roll, pitch or yaw.

FIG. 30B illustrates an example cue symbol where the window symbol is pointing towards the sky (window angled up) and pitched up.

FIG. 30C illustrates an example cue symbol where the window symbol is pointing towards the lunar terrain (windows angled down), pitched down, yawed left.

FIG. 30D illustrates an example cue symbol where the window symbol is pointing toward lunar terrain (windows 90 degrees down), pitched up.

FIG. 30E illustrates an example cue symbol 230 where the window symbol is in line with the horizon, rolled left, yawed left.

FIG. 31 illustrates a series of display screens indicating pilot inputs over time to indicate multi-pulse commands.

FIG. 32 illustrates a series of display screens indication pilot inputs over time to indicate multi-pulse commands.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including,” “comprising,” or “having.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions can be practiced with plus or minus 50 percent of the values indicated rounded to three significant figures. In a refinement, concentrations, temperature, and reaction conditions can be practiced with plus or minus 30 percent of the values indicated rounded to three significant figures of the value provided in the examples. In another refinement, concentrations, temperature, and reaction conditions can be practiced with plus or minus 10 percent of the values indicated rounded to three significant figures of the value provided in the examples.

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

Described herein is a display system for a vehicle, such as an aircraft, satellite spacecraft, space station, forms or orbital vehicles, rovers, etc. The vehicle may be manned by a pilot or driver either located within the vehicle, or remote from the vehicle. A vehicle display may be included within the vehicle, and/or remote from the vehicle. The display may be configured to provide visual indicia to the pilot and others to assist in operating the vehicle. In response to certain inputs from the pilot, the vehicle display may update to provide updated visual confirmation to the pilot. Additional information is displayed in response to data signals provided from other vehicle systems.

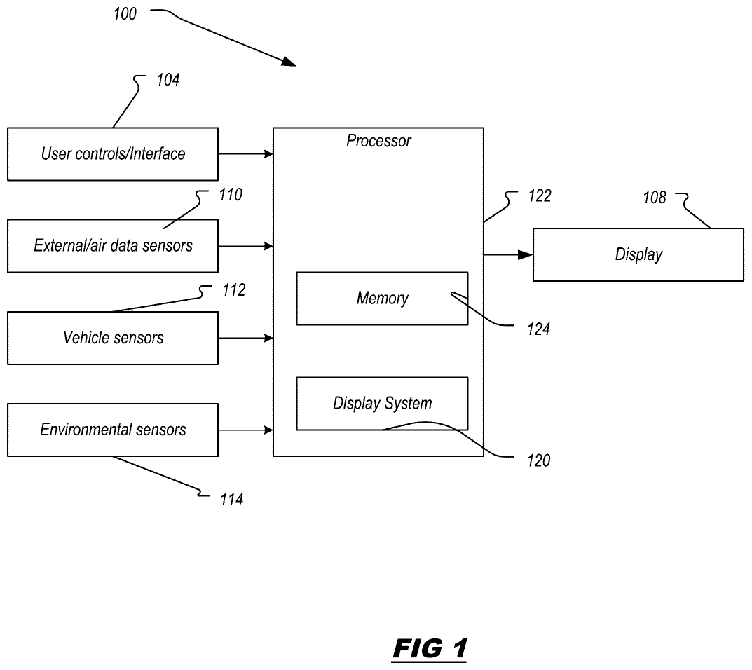

FIG. 1 illustrates a block diagram of an example vehicle system 100, including a display system 120. The system 100 may be part of a vehicle such as aircrafts, motor vehicles, rotorcrafts such as helicopters, unmanned aerial vehicles, spaceplanes, space stations, satellites, etc. The system 100 may include user interface(s) or user controls 104 for controlling the vehicle. These controls 104 may be physical components configured to control the vehicle via user input. The controls 104 may include, in one example, a yoke or control stick to control the pitch and roll of the vehicle. Rudder pedals may control side to side movement. The controls 104 may include a user interface configured to receive additional user input and may include a touch screen, buttons, microphone for receiving voice commands, etc. The controls 104 may receive inputs to control other parts of the aircraft such as engines, flaps, etc. The controls 104 may also be configured to receive commands related to a display 108, such as certain elements and components to display, etc.

The system 100 may include various sensors for gathering data that may be used by a processor 122 and a display system 120 to present information via the display 108. The system may include external or air data sensors 110, vehicle sensors 112, and/or environmental sensors 114. The sensors may provide data to the display system 120 and the processor 122 may provide and generate a display for the display unit 108 based at least on a portion of the data, as well as commands received from the user controls 104.

The air data sensors 110 may be configured to measure parameters generally related to features external to the vehicle such as airspeed, altitude, and other atmospheric conditions. Such sensors may include temperature sensors, accelerometers, angle of attack (AoA) sensors, as well as pressure sensors for gathering the atmospheric pressure.

The vehicle sensors 112 may include vehicle specific sensors such as engine sensors including temperature, vibration, pressure, speed, fuel level, weight sensors. Such sensors may monitor internal status of systems such as the engine and other components. Other sensors such as accelerometers, gyroscopes, load sensors, etc., may be included to further provide helpful data to the vehicle. Cabin pressure and air quality sensors may also be included, as well as sensors related to collision avoidance, including radar, lidar, ultrasonic, etc. The vehicle sensors 112 may also provide positional data such as roll, pitch, and yaw information.

The environmental sensors 114 may include other environment related sensors such as weather radars, humidity sensors, navigation related sensors (relating to the vehicle as well as targets), inertial movement sensors, etc.

The processor 122 may be capable of performing may include a machine controller and any additional controllers provided for controlling any of the components of the system 100. Many known types of controllers can be used for the processor 122. It is contemplated that the processor 122 is a microprocessor-based controller that implements control software and sends/receives one or more electrical signals to/from each of the various working components to implement the control software.

The processor 122 may also include or be coupled to a memory 124 configured to include instructions and databases to carry out the systems and processes disclosed herein. The processor 122 may be programmed to instruct the display to project visual indicia.

As explained, the display system 100 may be capable producing several visual attributes to be presented via the display, including:

Directional Hover Cue-When evaluating the current implementation during SME evaluations, the seed for a redesigned cue came about. The problem with the existing hover cue stemmed from the difficulty in transitioning from piloting the ownship cue on the PFD to the hover cue on the HSD, which appear visually different on different dimensional planes. On the PFD, the pilot controls a joystick to navigate a simulated 3D space, while on the HSD, a mental translation must be done to translate joystick movement to a 2D plane. Additionally, there may be latency in the hover cue due to low control power conditions which means the hover cue may be traveling in one direction while control input is steering a different direction, used for manual control modes only.

Bergmann Predictive Cue-Cue was created to facilitate piloting of a vehicle with low control authority. Pilots can anticipate some latency in vehicle movement, but the expected latency in movement may have impacted flight performance.

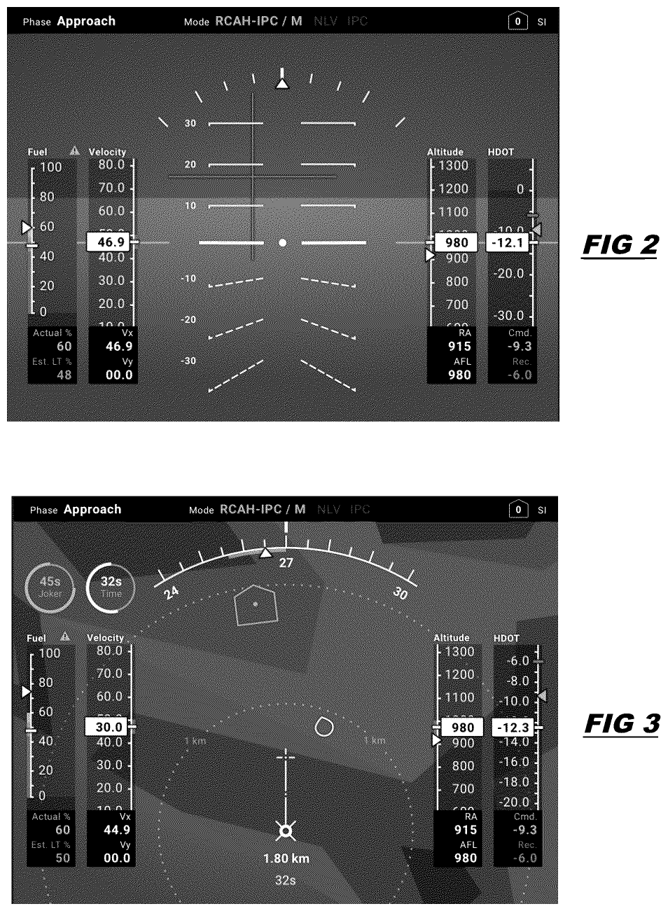

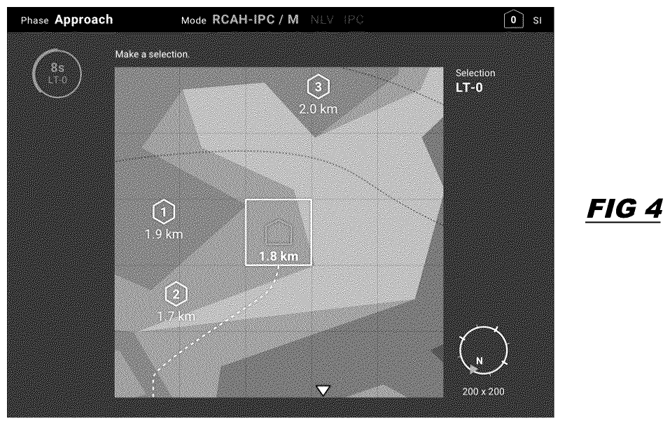

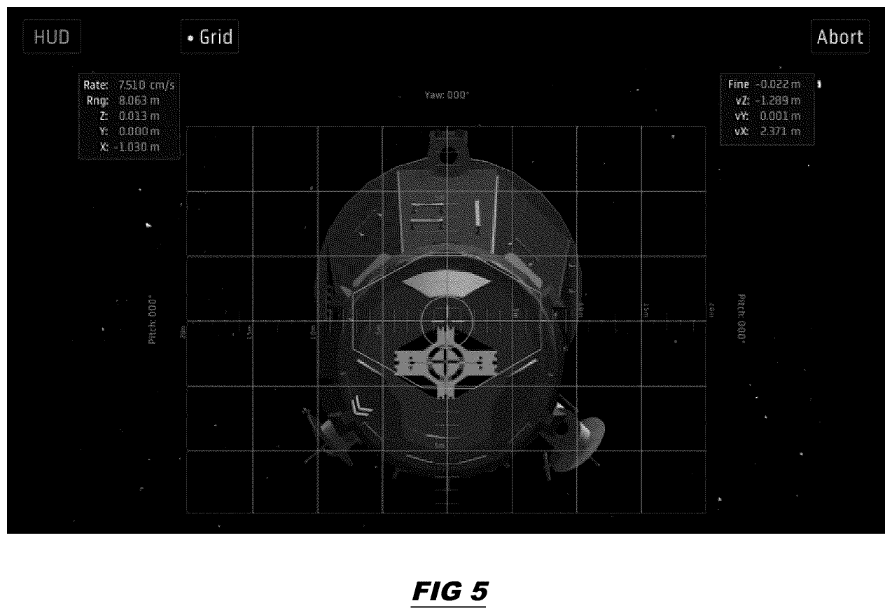

FIGS. 2-4 present example display screens of differing formats. For example, FIG. 2 illustrates an example Primary Flight Display (PFD) for lunar decent; FIG. 3 illustrates an example Horizontal Situation Display (HSD); and FIG. 4 illustrates an example Hazard Map (HM) Display.

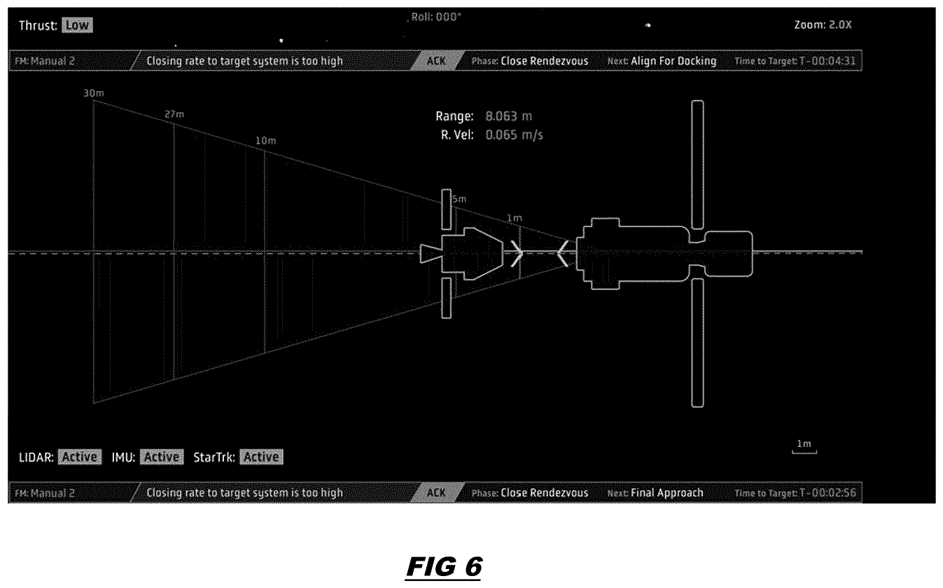

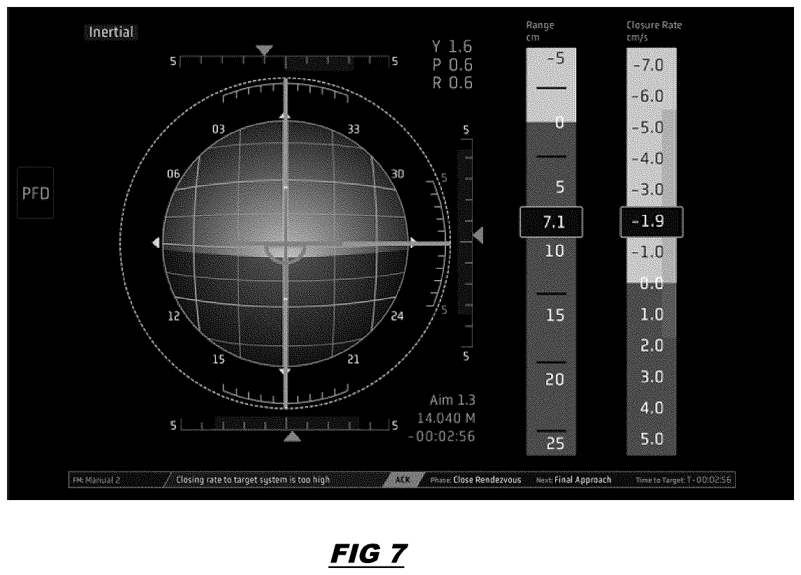

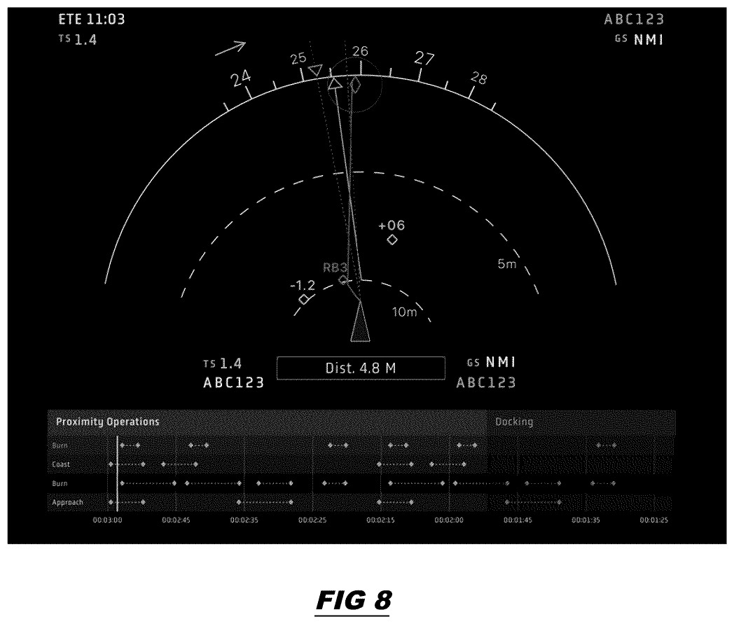

FIGS. 5-8 illustrate example Rendezvous Proximity Operations and Docking (RPOD) Pilot Display Formats for close rendezvous with intended order for representative layout. FIG. 5 illustrates an example Head-up Guidance Display (HUD); FIG. 6 illustrates an example Vertical Navigation Situation Display (VNAV); FIG. 7 illustrates an example Primary Flight Display (PFD) for RPOD; and FIG. 8 illustrates an example Horizontal Navigation Situation Display (HNAV). The Task Timeline shown at the bottom of the example display interfaces is exemplary.

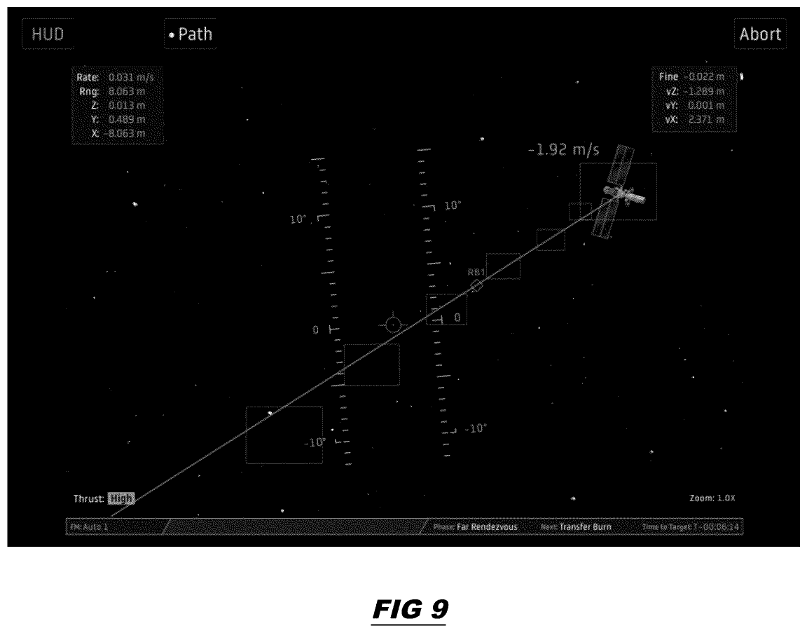

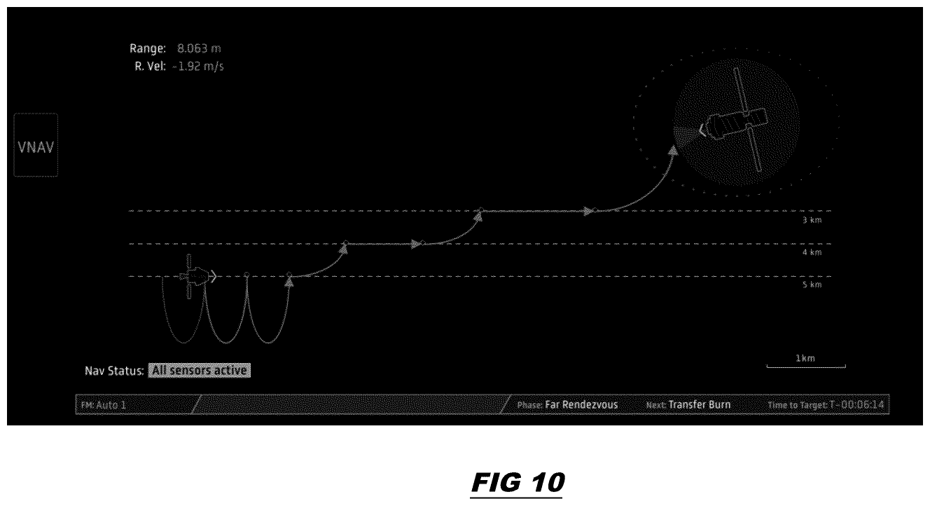

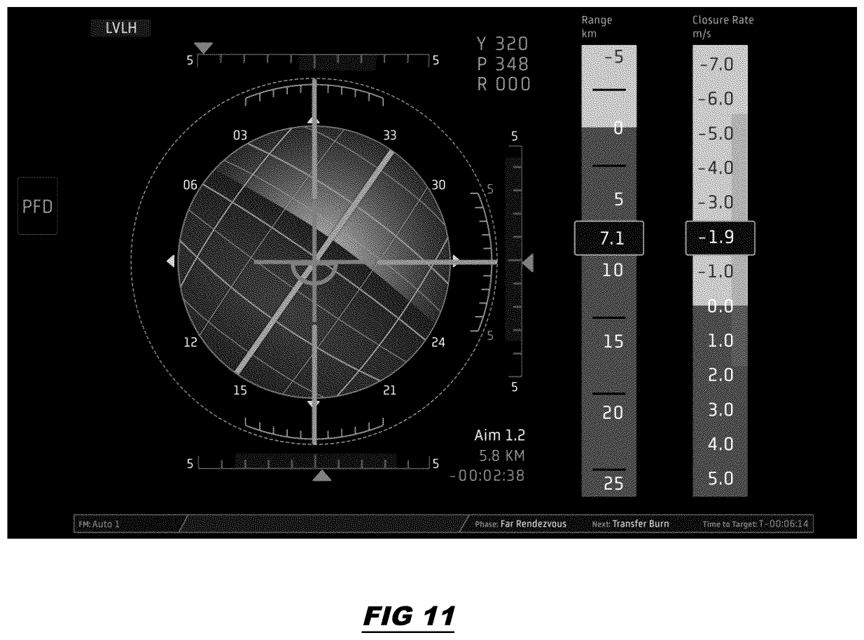

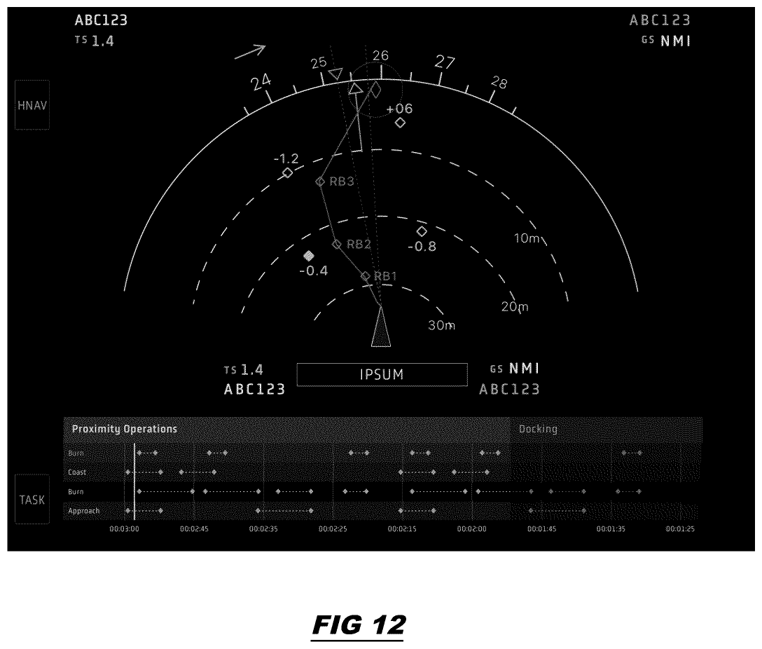

FIGS. 9-12 illustrate RPOD Pilot Display Formats for far rendezvous with intended order for representative layout. FIG. 9 is another example HUD; FIG. 10 is another example Vertical VNAV; FIG. 11 is another example of a PFD for RPOD; and FIG. 12 is another example HNAV.

The display may include various landing features and common landing components. These components may appear in a standard format and location for all landing display units.

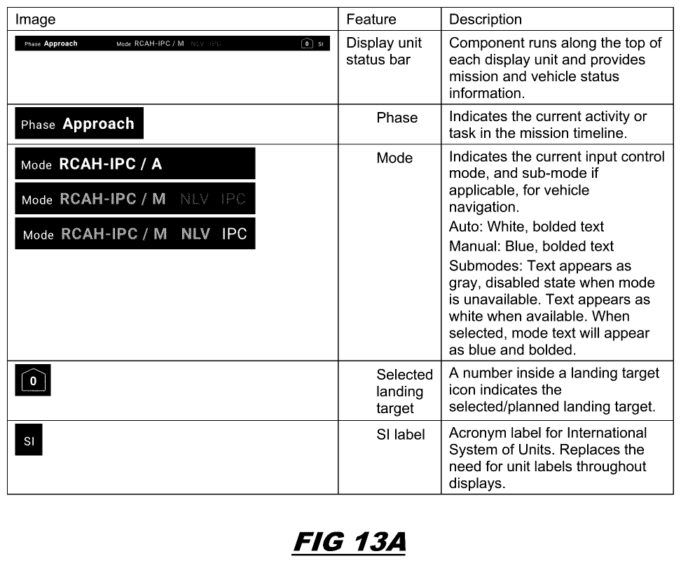

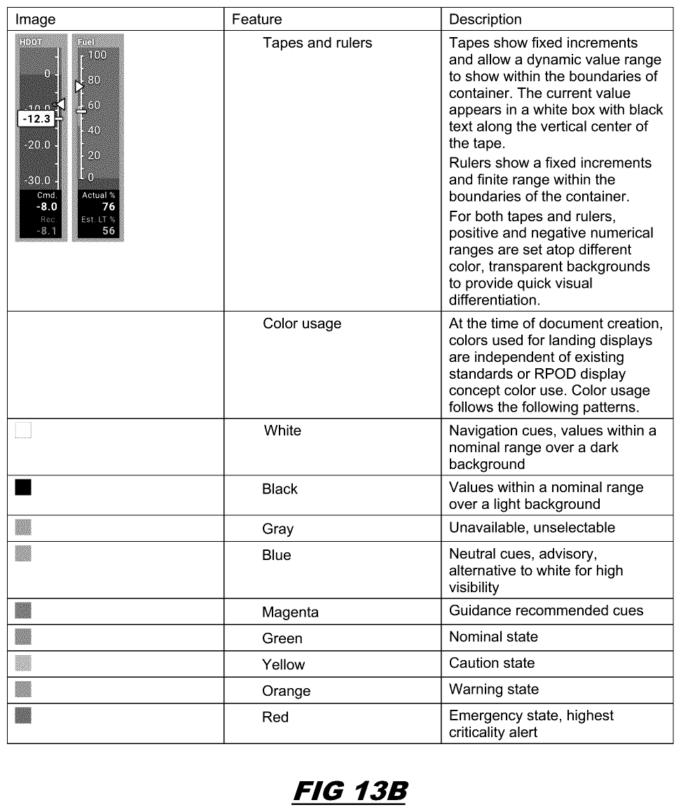

FIGS. 13A and 13B illustrate an example chart of example landing components.

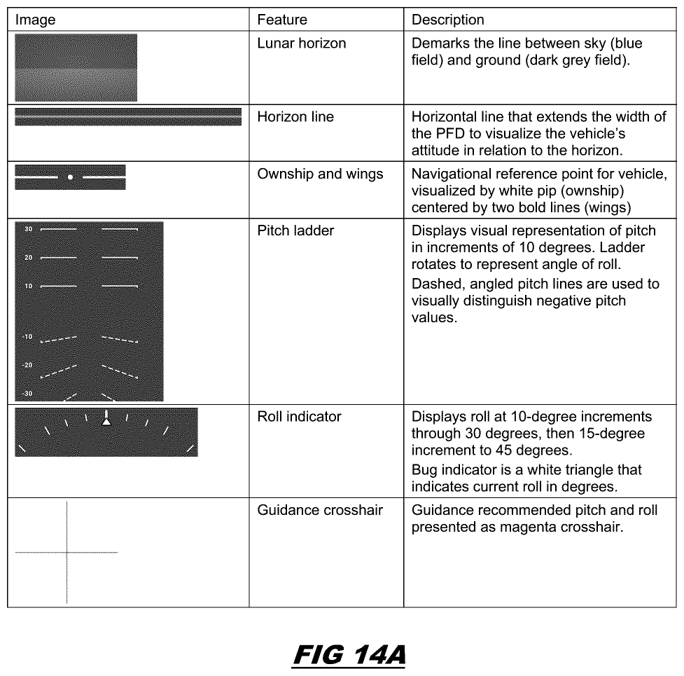

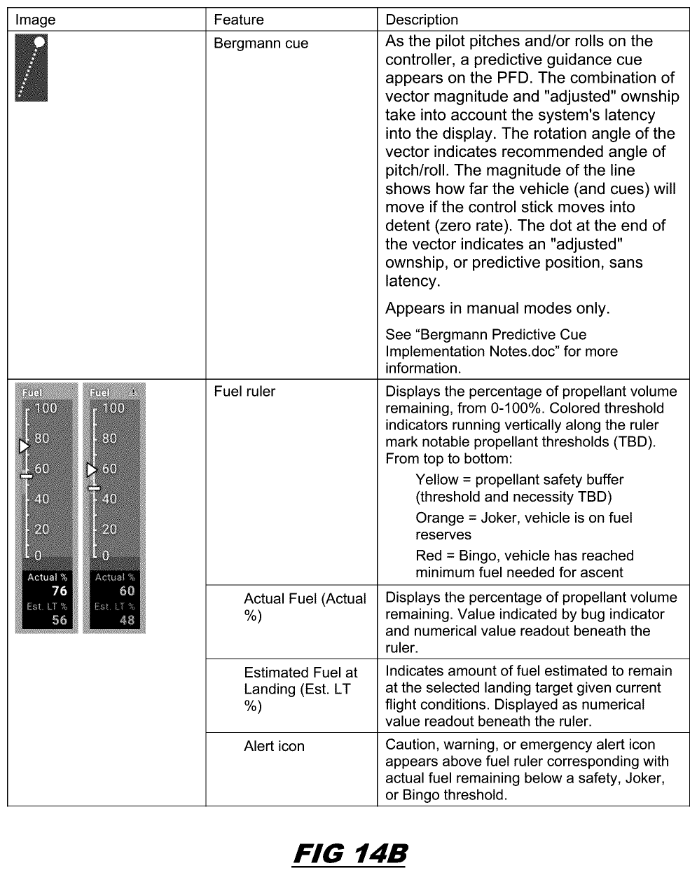

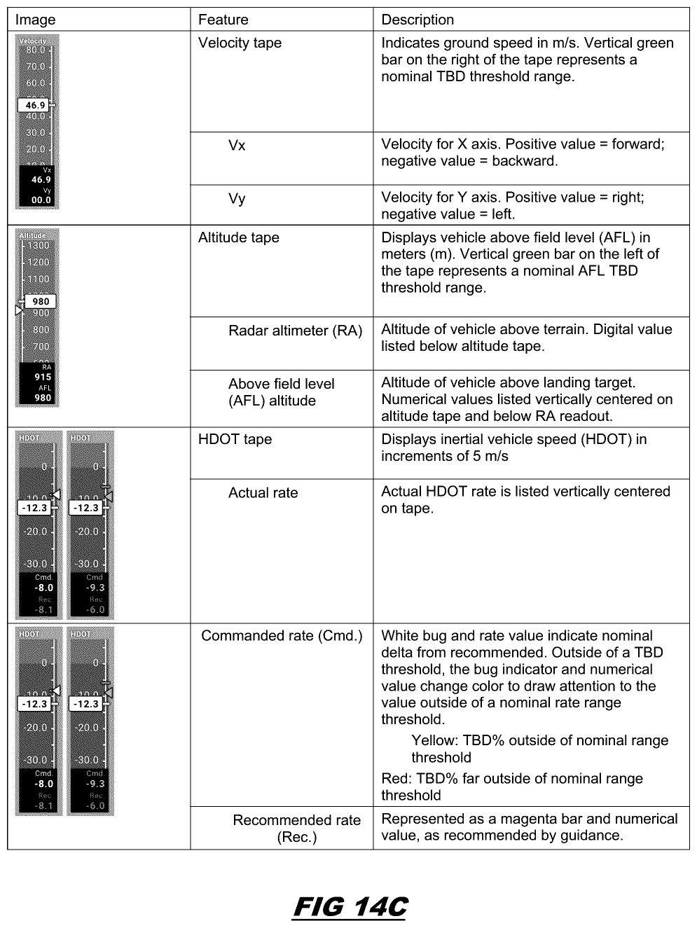

FIGS. 14A, 14B and 14C illustrate an example chart of example components specific to the PFD, similar to the example shown in FIG. 2. These components may aid in in vehicle situational awareness, navigation during approach, and vehicle attitude orientation. The simulated horizon background orients to the surrounding environment based on the vehicle's position and attitude.

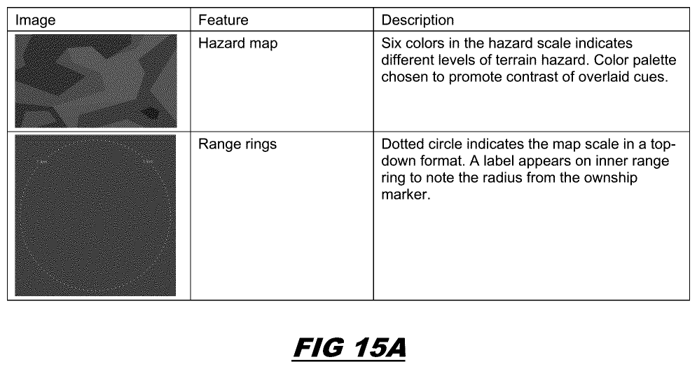

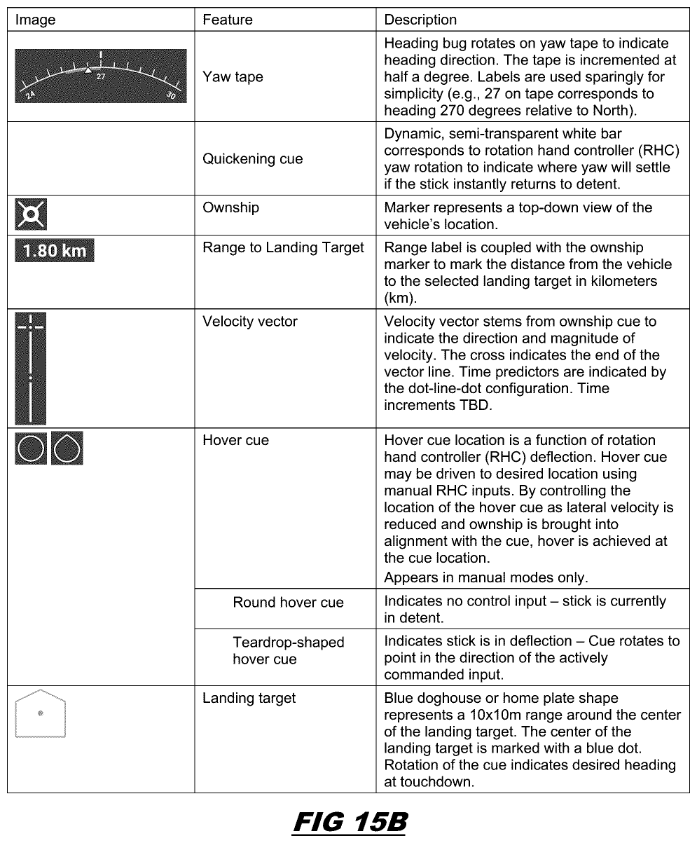

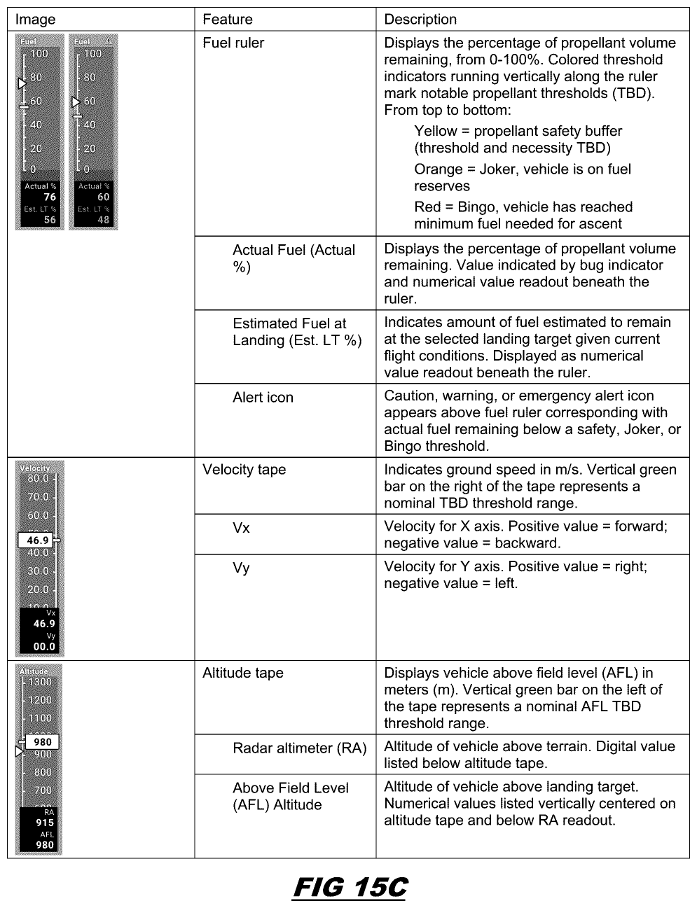

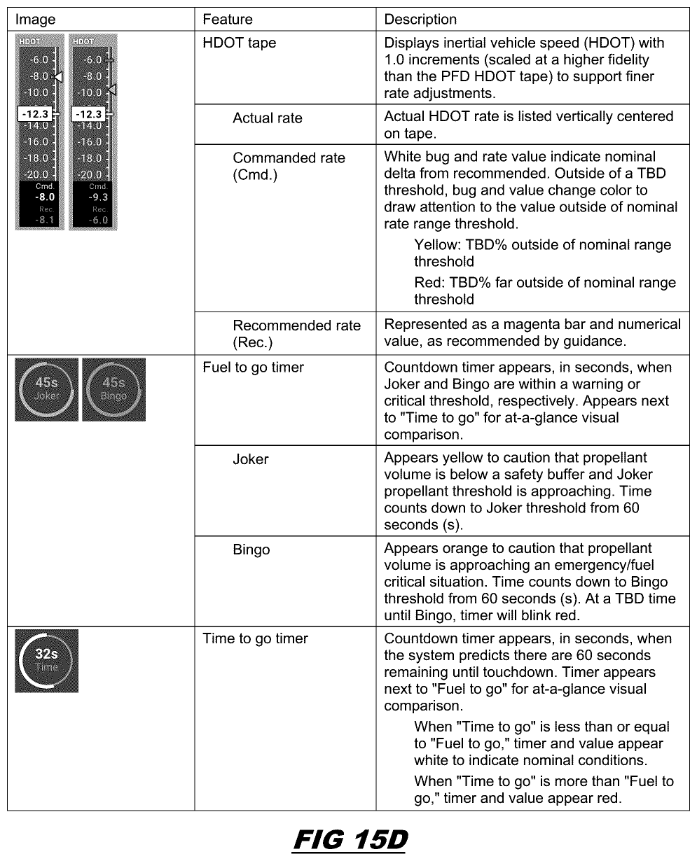

FIGS. 15A, 15B, 15C and 15D illustrate an example chart of example components specific to the Horizontal Situation Display (HSD), similar to the example shown in FIG. 3. These components may aid in vehicle situational awareness during final approach and terminal descent, as well as navigation and vehicle orientation. A simulated background provides a basic awareness of the terrain and distance to target. As vehicle sensors register terrestrial hazards, the background shows a color-coded topographic hazard map.

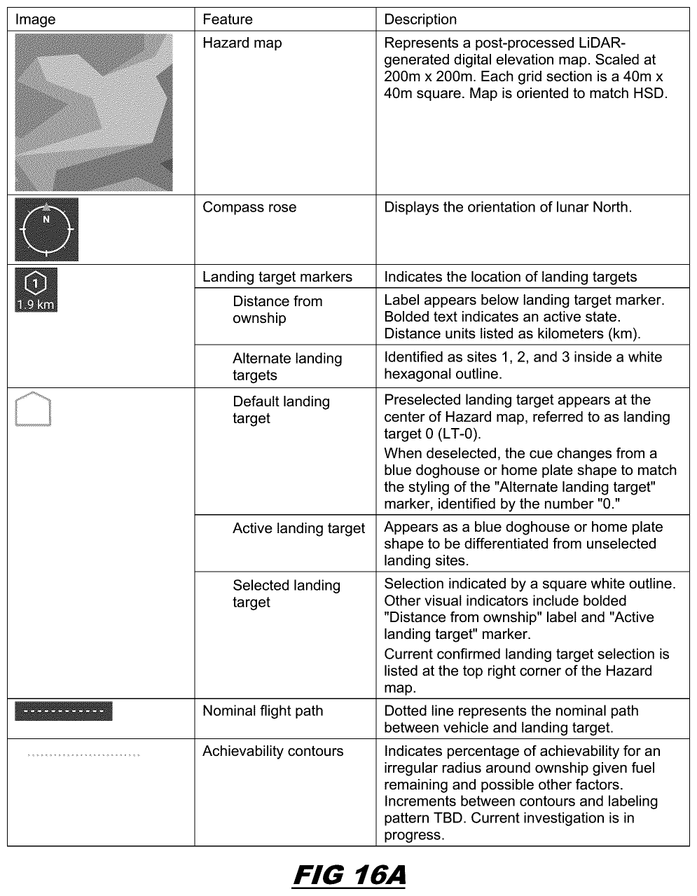

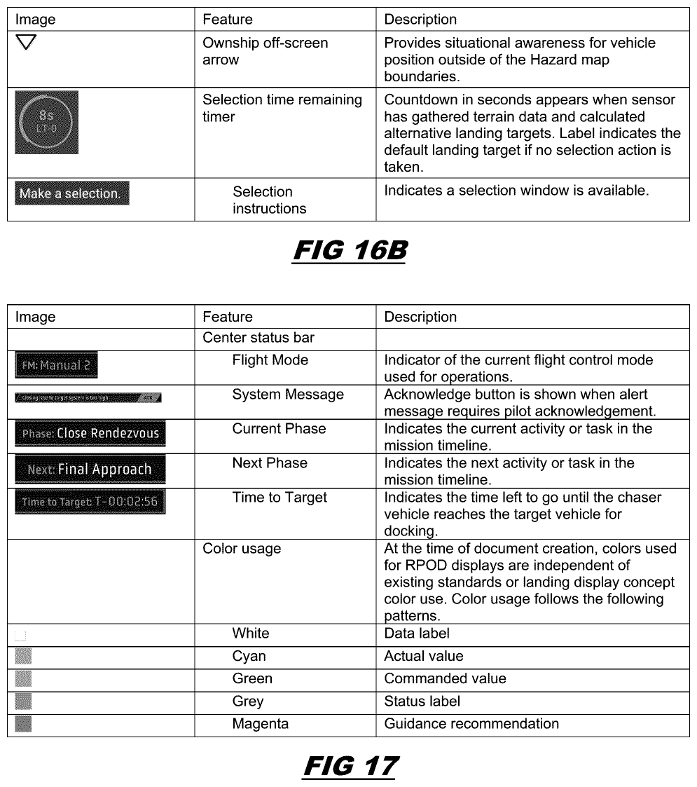

FIGS. 16A and 16B illustrate an example chart of example components specific to the Hazard map, similar to the example shown in FIG. 4. These components are unique to the Hazard Map Display to aid in manual selection of an alternate landing target during approach.

Rendezvous, Proximity Operations and Docking (RPOD) Features. RPOD includes procedures and data related to bringing two vehicles together, or to maneuver such vehicles into precise relative positions. Far Rendezvous refers to the phase in which the vehicle is on an orbit intended for RPOD relative to the target, up to entry of the Approach Sphere (AS). Proximity Operations refers to operations which take place withing the AS. Further detailed descriptions of these phases may be found in the International Rendezvous System Interoperability Standards (IRSIS)⁺.

FIG. 17 illustrates an example chart of example RPOD components. The components may relate to Far Rendezvous, Proximity operations, or both.

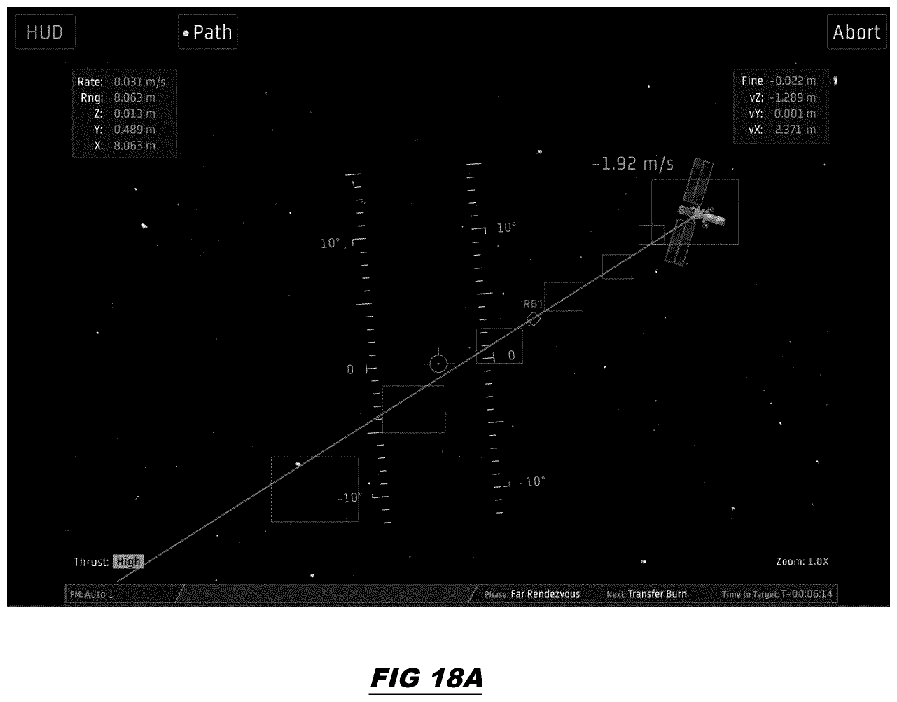

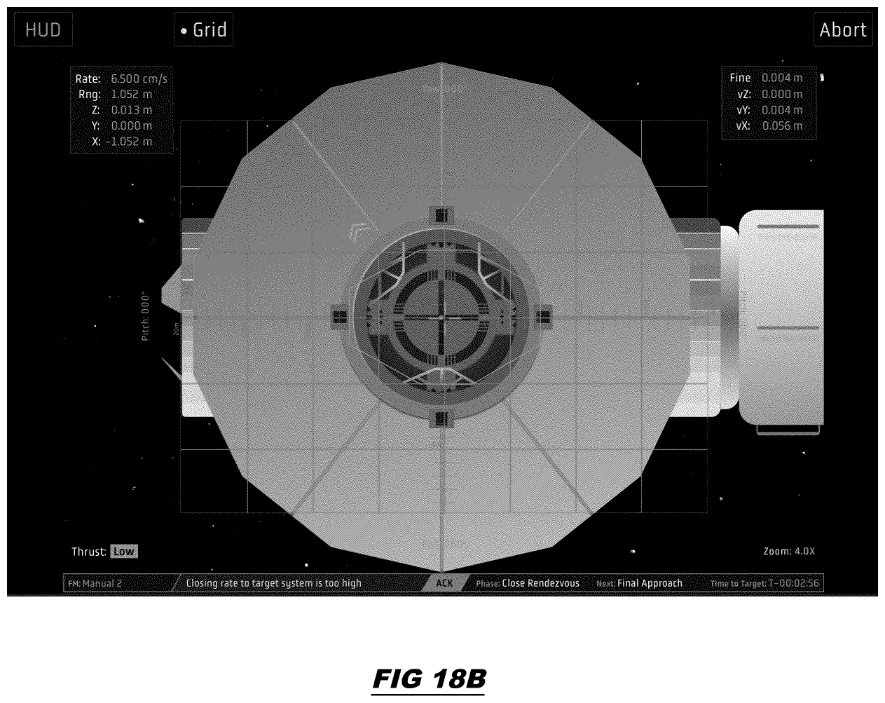

FIGS. 18A and 18B illustrates example HUD live camera feed displays where a chaser's vehicle's approach other target vehicle capture system is support by a synthetic path and grid guidance, attitude, and navigation cues.

FIG. 18A illustrates an example Far Rendezvous while FIG. 18B illustrates proximity operations.

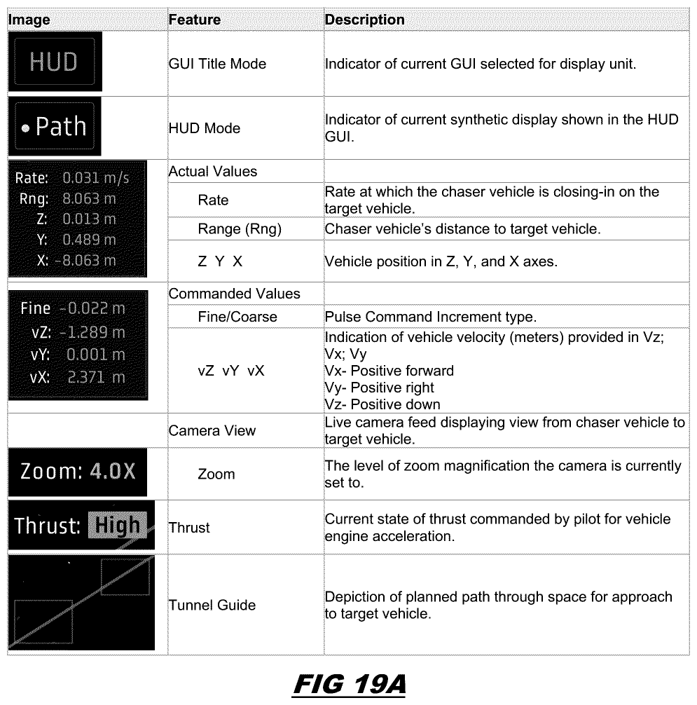

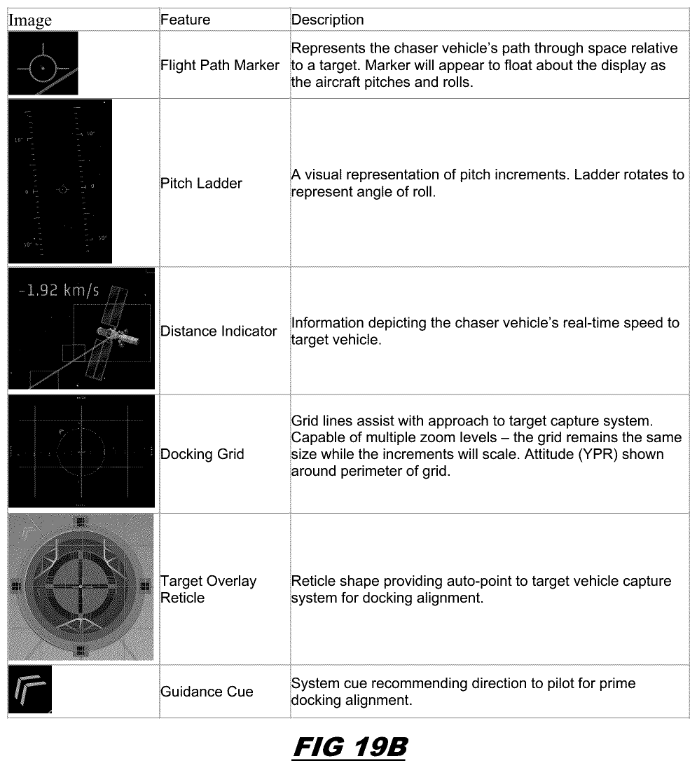

FIGS. 19A and 19B illustrate an example chart of example HUD components.

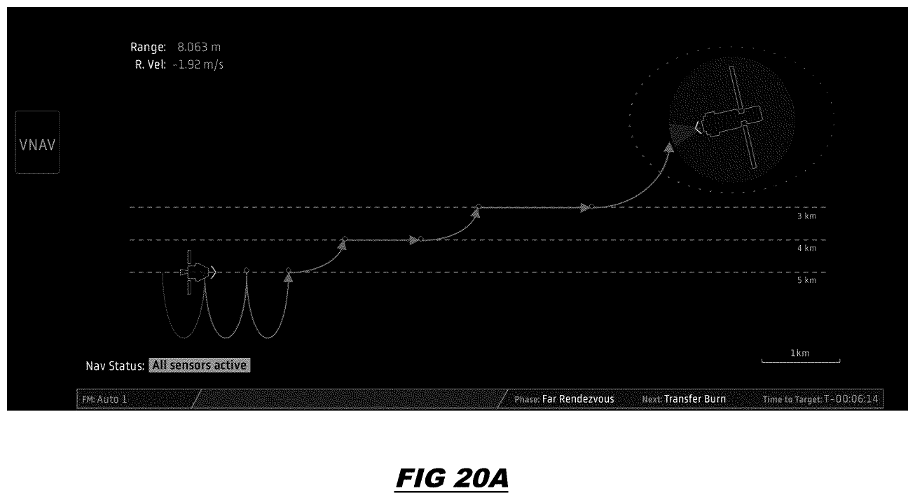

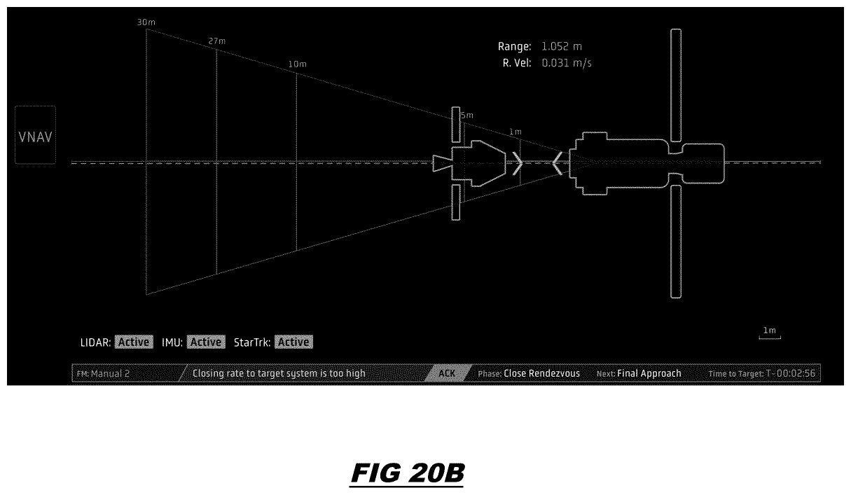

FIGS. 20A and 20B illustrate example Vertical Navigation Situation Displays (VNAV). This 2-D profile view displays the chaser vehicle's flight path to target. It enables crew to maintain accurate and consistent relative positioning for precise approach to Gateway during NRHO.

FIG. 20A illustrates an example Far Rendezvous while FIG. 20B illustrates proximity operations.

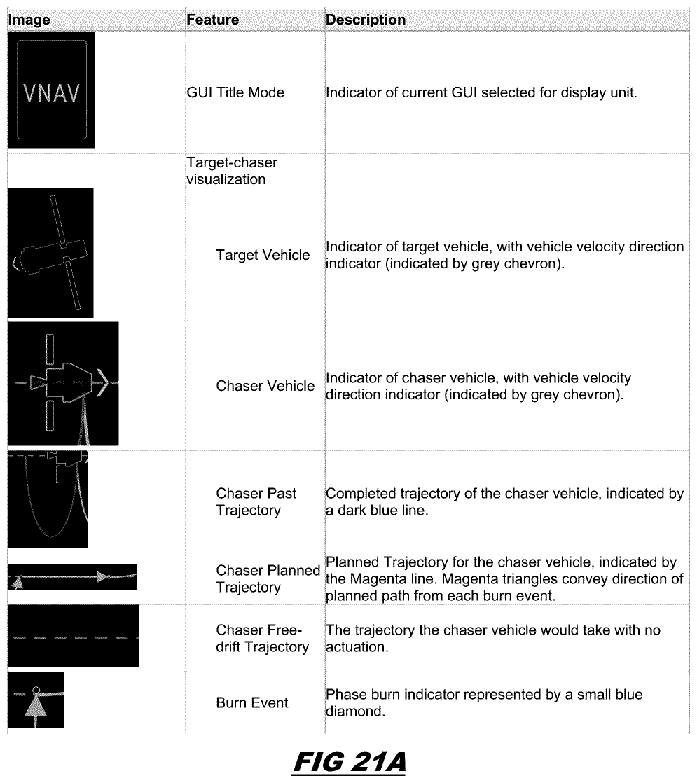

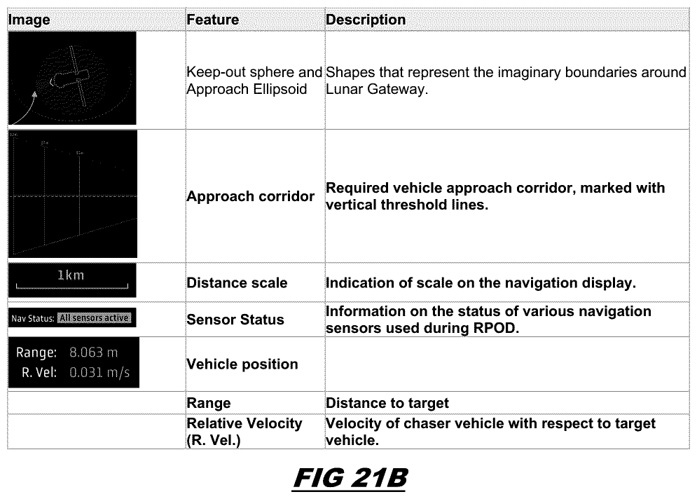

FIGS. 21A and 21B illustrate an example chart of example VNAV components.

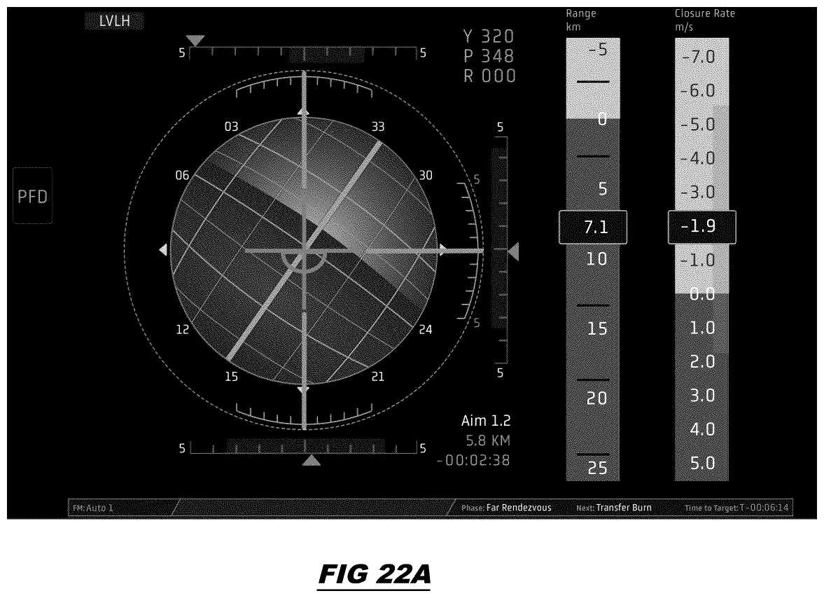

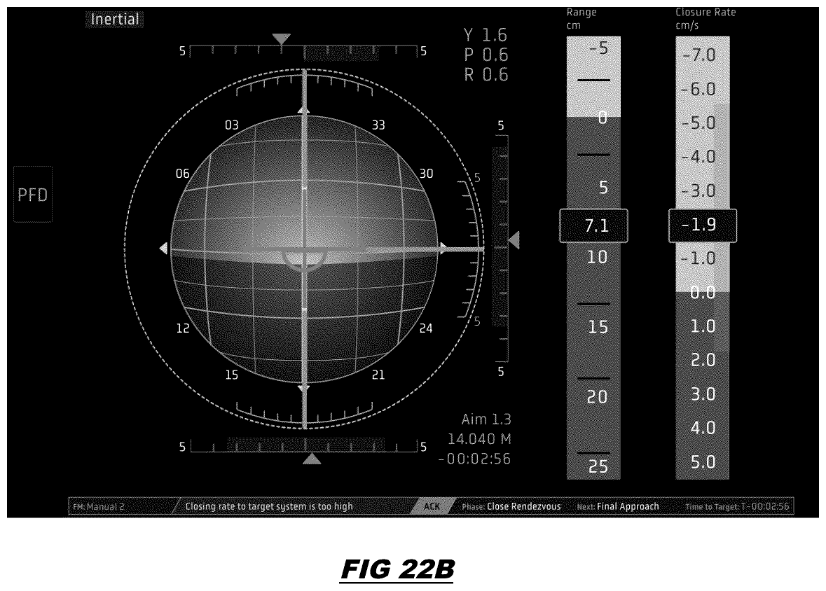

FIGS. 22A and 22B illustrate example Primary Flight Displays (PFD). This display depicts the ADI ball with basic attitude information including ownship, pitch ladder, horizon line, range and closure rate tapes, and distance to next aimpoint.

FIG. 22A illustrates an example PFD for RPOD Far Rendezvous while FIG. 22B illustrates an example PFD for RPOD proximity operations.

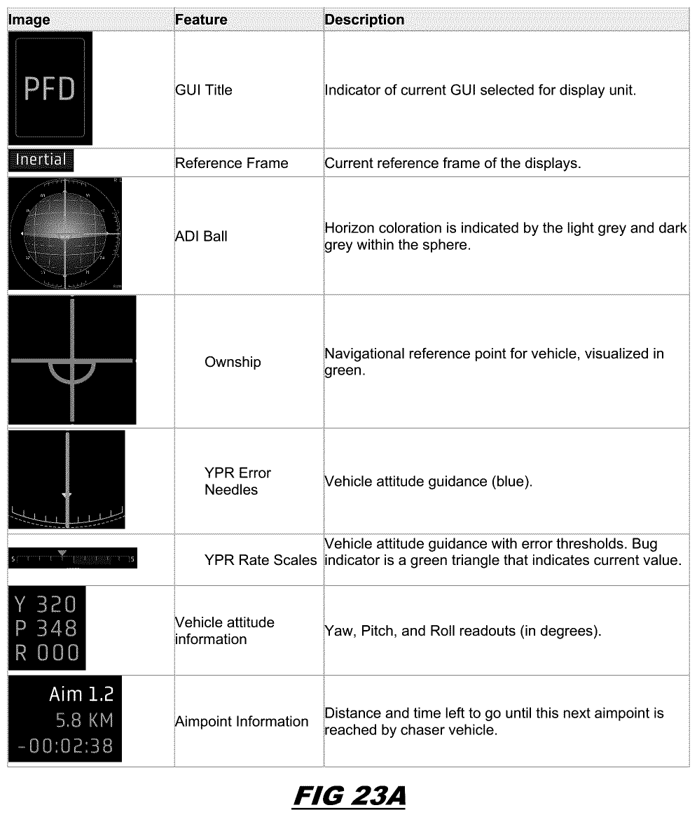

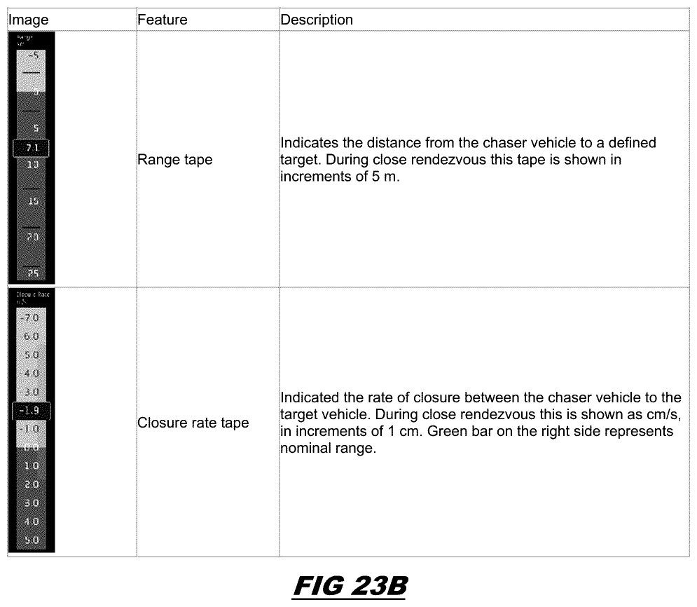

FIGS. 23A and 23B illustrate an example chart of example RPOD PFD components.

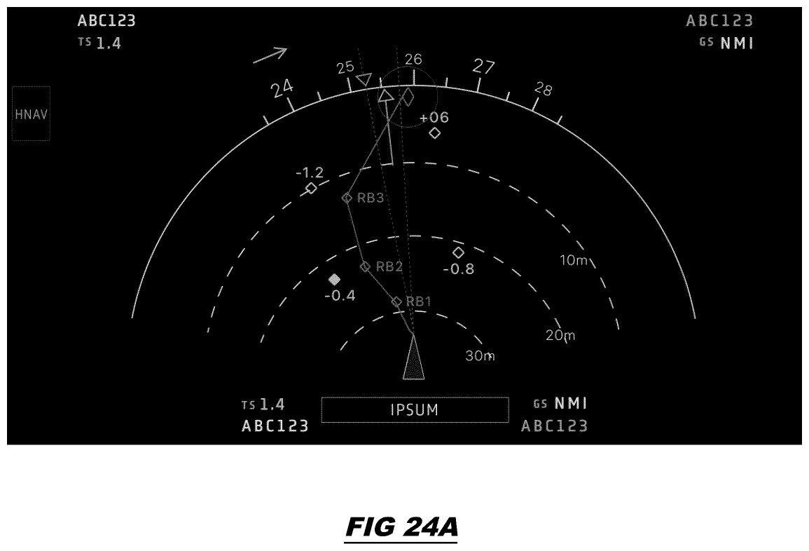

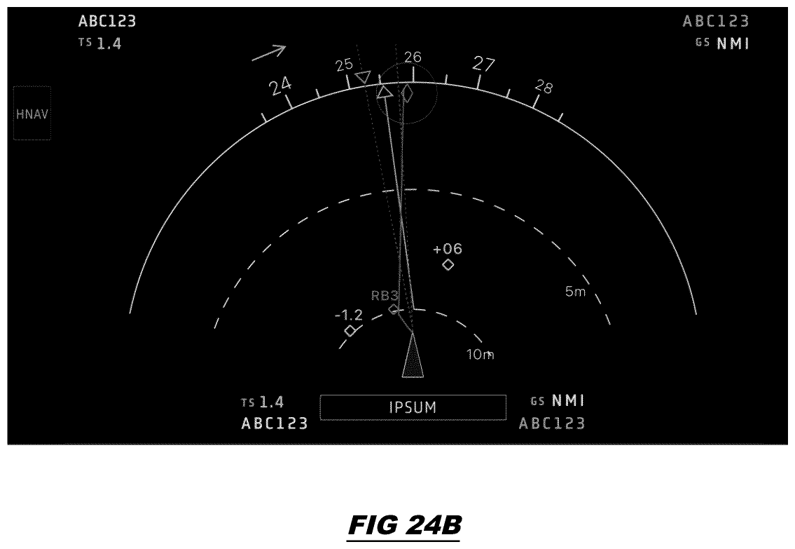

FIGS. 24A and 24B illustrate an example Far Rendezvous for Horizontal Navigation Situation Displays (HNAV). This 2-D top-down, track-up mode view displays the ownship's progress along its planned flight path including burn sequence and aimpoints.

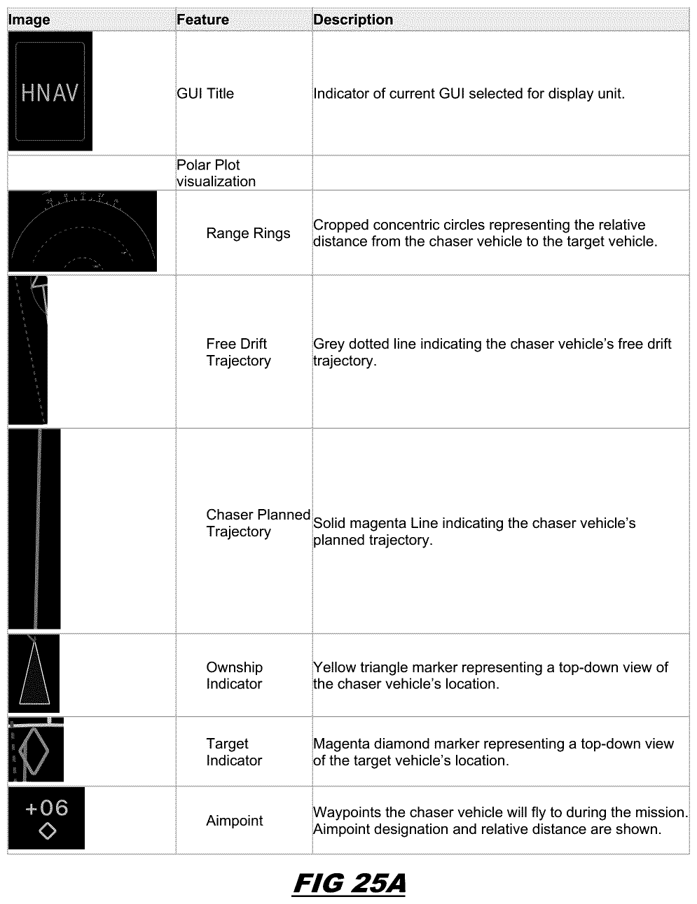

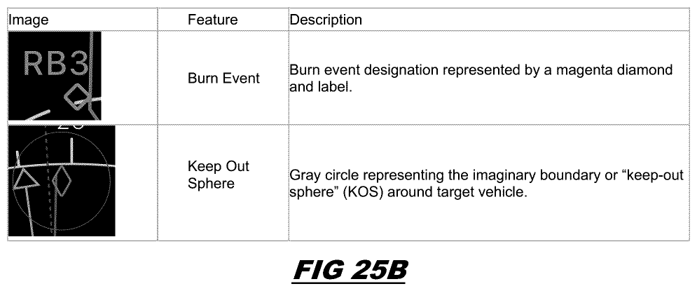

FIGS. 25A and 25B illustrate an example chart of example HNAV components.

### Distinctive Target Overlay for RPOD Notes

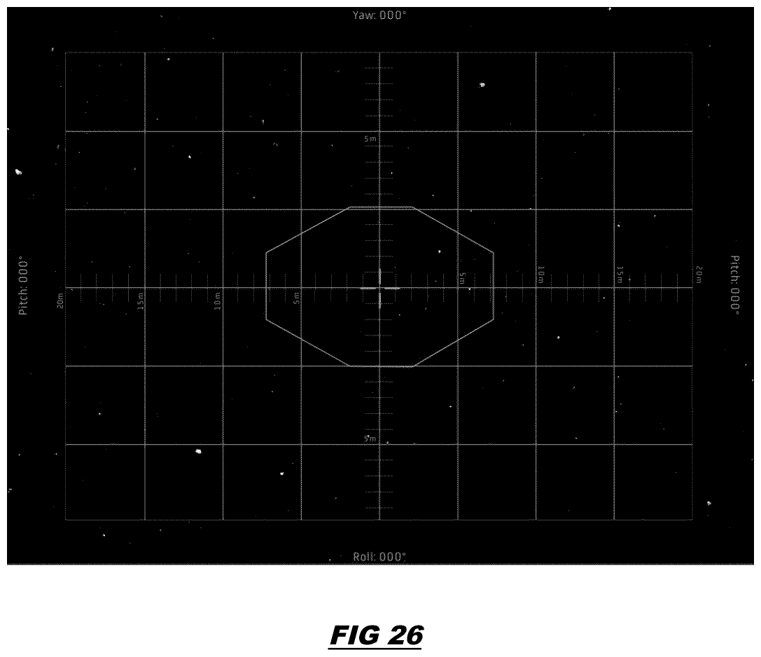

FIG. 26 illustrates an example docking grid with distinctive target overlay that is currently being explored for the Rendezvous, Proximity Operations, and Docking (RPOD) heads-up display (HUD).

When the chaser vehicle enters the close rendezvous phase of the flight, the synthetic overlay transitions from a visual approach path to an octagonal reticle. Within the octagon shape is a cross that represents the actual cross-bar mounted within the Lunar Gateways capture system. The octagon in the synthetic display may not have a fill color, allowing pilots an unobstructed view to align the chaser vehicle to the fiducials with degrees of precision.

Further, propagating the state of chaser vehicle by showing a “projection” of the docking target in the HUD could be contemplated. The approach corridor reticle includes an octagon containing a cross-bar, similar to the example shown in FIG. 5.

A Bergmann Predictive cue could also be implemented into a lunar landing simulator In this example, as the pilot pitches and/or rolls on the controller, a predictive guidance cue appears on the PFD. The combination of vector magnitude and “adjusted” ownship take into account the system's latency into the display. The rotation angle of the vector indicates recommended angle of pitch/roll. The magnitude of the line shows how far the vehicle (and cues) will move if the control stick moves into detent (zero rate). The dot at the end of the vector indicates an “adjusted” ownship, or predictive position, sans latency.

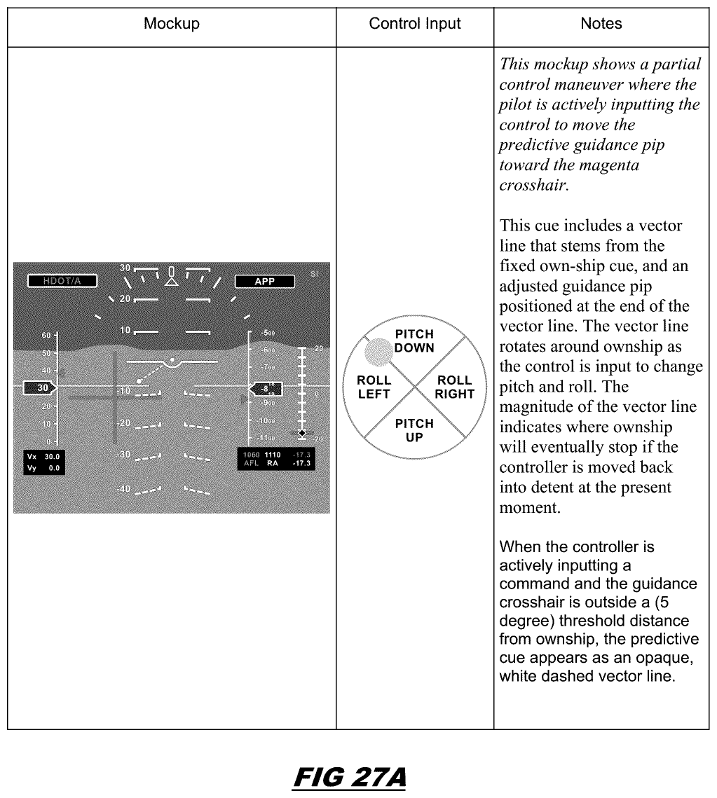

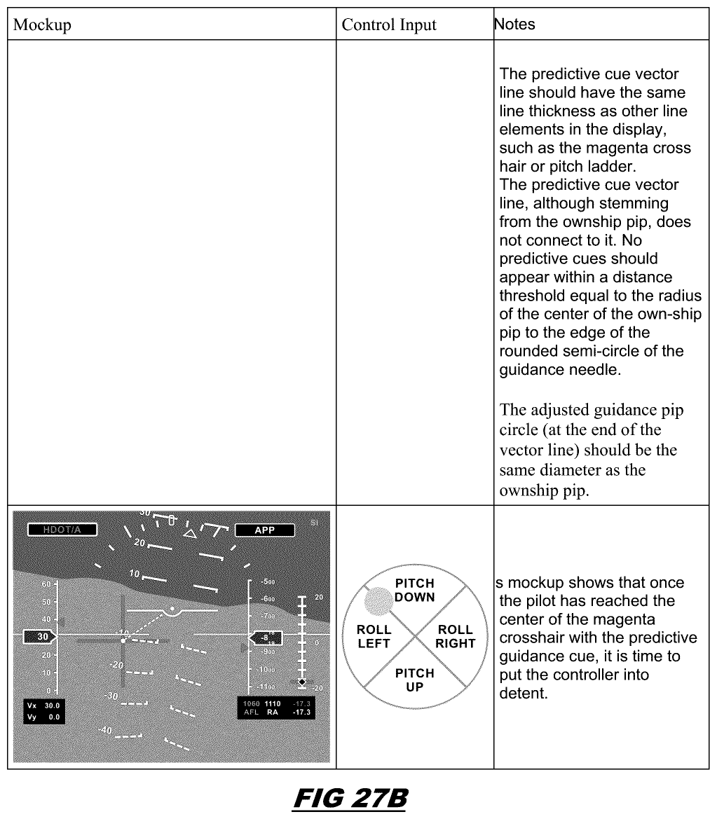

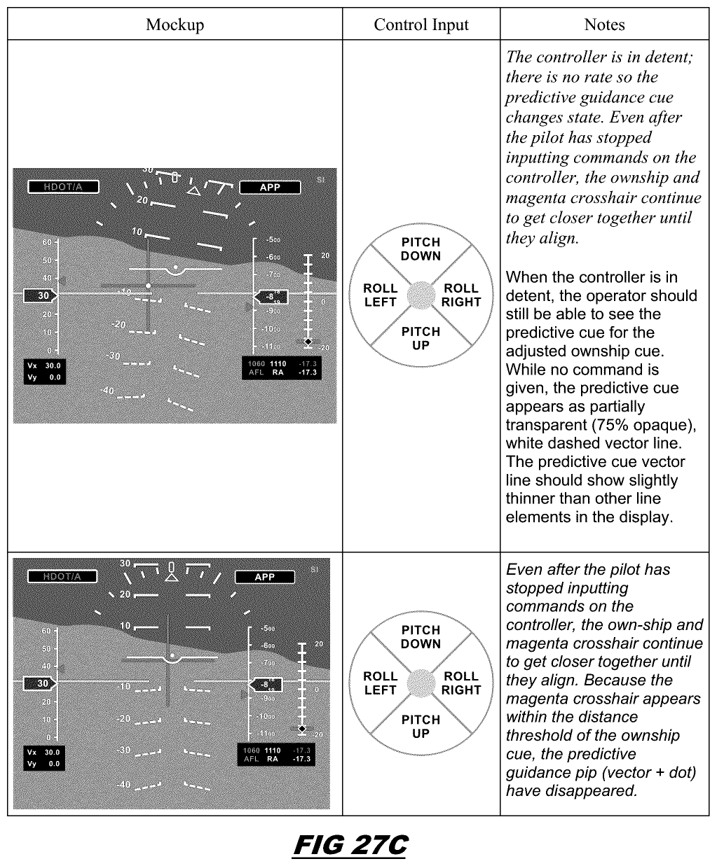

FIGS. 27A, 27B, and 27C illustrate an example chart of example Bergmann Predictive cues and components. In these examples, the pilot has established a rate and is pitching down and rolling left to attempt to align the guidance pip at the magenta crosshair.

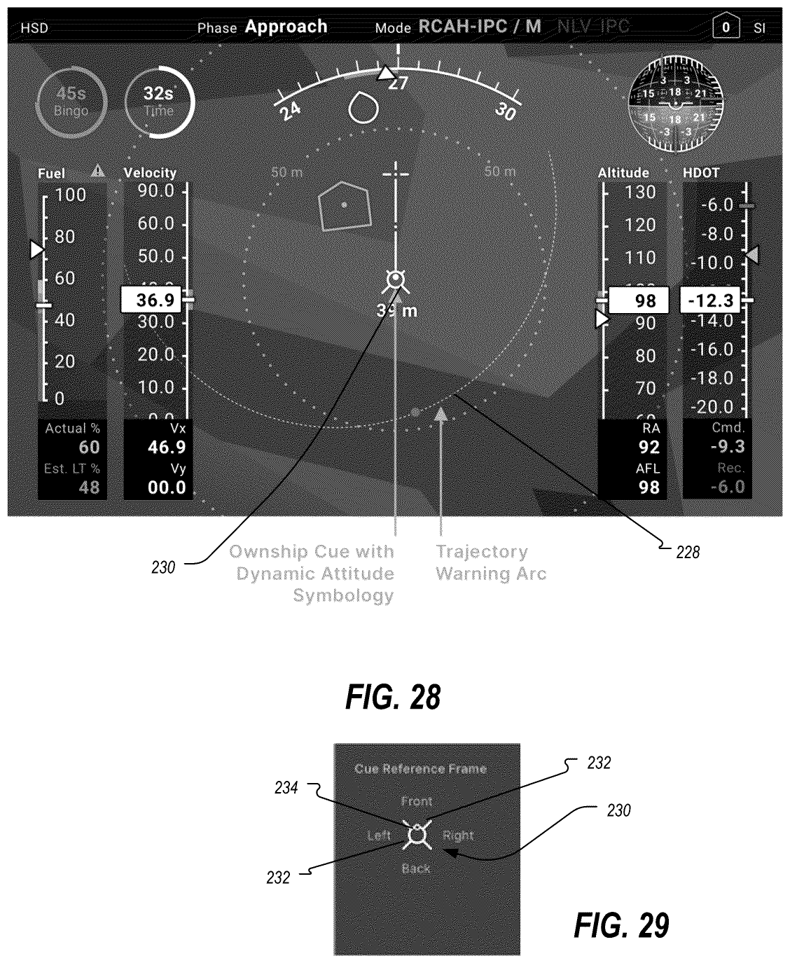

FIG. 28 illustrates an example display having a trajectory warming arc cue 228 for the Horizontal Situation Display (HSD). Such cue 228 may facilitate manual piloting and attitude of the vehicle for a windows down fly-over trajectory. The trajectory warning arc is a semi-circular line surrounding the landing target at a fixed radius (e.g., 75 m from the landing target center point). The opening of the arc is rotated toward the approaching vehicle heading. A dynamic waypoint, determined by vehicle guidance, slides along the arc perimeter as vehicle trajectory changes in real-time.

The example display may also include at least one ownship cue symbol 230. The ownship cue symbol 230 may be dynamic and may update based on vehicle attitude to indicate roll, pitch, and yaw, in a two-dimensional, top-down view. The cue includes updated behaviors for vehicle four-leg positions and the addition of window position symbology. The cue symbol 230 dynamically changes in sync with the change in the vehicle's attitude to help provide situational awareness and a frame of reference, especially in a windows down fly-over trajectory.

FIG. 29 illustrates an example ownship cue symbol 230 having a plurality of legs 232, creating a reference frame for front, left, back and right. In this example, four legs extend from the center of the cue. The ownship cue symbol 230 may also include a window indicator 234. The legs 232 and the window indicator 234 may dynamically change to provide the frame of reference to the pilot.

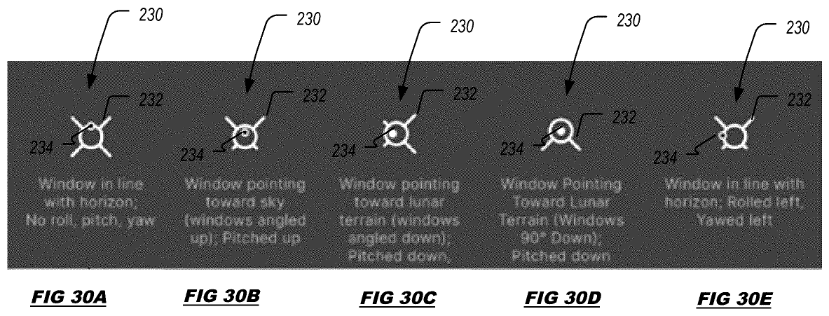

FIGS. 30A-E illustrate various examples for the ownship cue references based on the roll, pitch, and yaw of the vehicle. In generally, as the vehicle rolls left, the two legs on the left side of the cue may shorten to simulate the perspective of two left legs beneath the vehicle. As the vehicle rolls right, the two legs on the right side of the ownship cue may get shorter to simulate the perspective of two right legs beneath the vehicle.

With respect to pitch, at the vehicle pitches up from neutral, the two legs on the back side of the ownship cue get shorter to simulate the perspective of the two back legs beneath the vehicle. The window symbol 234, represented by a small circle with a dark center, may move from the perimeter toward the center of the symbol to symbolize movement from out of the horizon to up toward the sky, and vice versa. As the vehicle pitches down from neutral, the two legs on the front side of the ownship cue may get shorter to simulate the perspective of the two front legs beneath the vehicle. The window symbol, represented by a filled white circle, may move from the perimeter of the ownship symbol towards the center of the ownship symbol, and vice versa.

Further, as the vehicle yaws left, all four legs and the window symbol 234 may rotate left around the perimeter of the symbol. As the vehicle yaws right, the same may rotate right around the perimeter of the ownship symbol. In the event of neutral attitude, where the vehicle has no roll or pitch, all four legs may appear the same length to simulate the perspective of a top-down vehicle view. With no yaw, the window symbol 234 appears at the front of the vehicle.

FIG. 30A illustrates an example cue symbol 230 where the window symbol 234 is in line with the horizon and the vehicle has no roll, pitch or yaw.

FIG. 30B illustrates an example cue symbol 230 where the window symbol 234 is pointing towards the sky (window angled up) and pitched up.

FIG. 30C illustrates an example cue symbol 230 where the window symbol 234 is pointing towards the lunar terrain (windows angled down), pitched down, yawed left.

FIG. 30D illustrates an example cue symbol 230 where the window symbol 234 is pointing toward lunar terrain (windows 90 degrees down), pitched up.

FIG. 30E illustrates an example cue symbol 230 where the window symbol 234 is in line with the horizon, rolled left, yawed left.

Thus, by the use of a single symbol, the pilot may realize quickly and easily the roll, pitch, and yaw of the vehicle via the simulate legs 232 and window symbol 234. Such determinations may be made via the display system 120 of the processor 122 in response to receiving vehicle data from the sensors, such as the vehicle sensor 112.

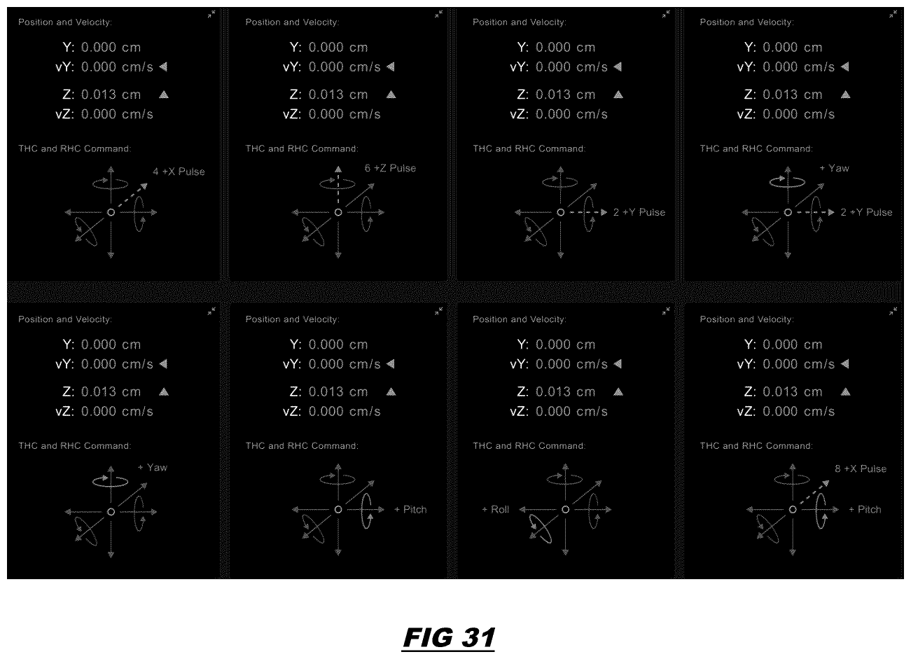

FIG. 31 illustrates a series of display screens indicating pilot inputs over time to indicate multi-pulse commands. As explained above, via the user interface, pilots may indicate commands. In some instances, the pilot may command multiple pulses at a time. These may be additive and iterative. In response to receiving such commands, the processor 122 and design system 120 may instruct the display to dynamical update based on the subsequent comments. In the example shown in FIG. 31, each time the pilot inputs a translation pulse command, the pulse is indicated via an arrow representative of that axis and text indicating the number of pulses is displayed.

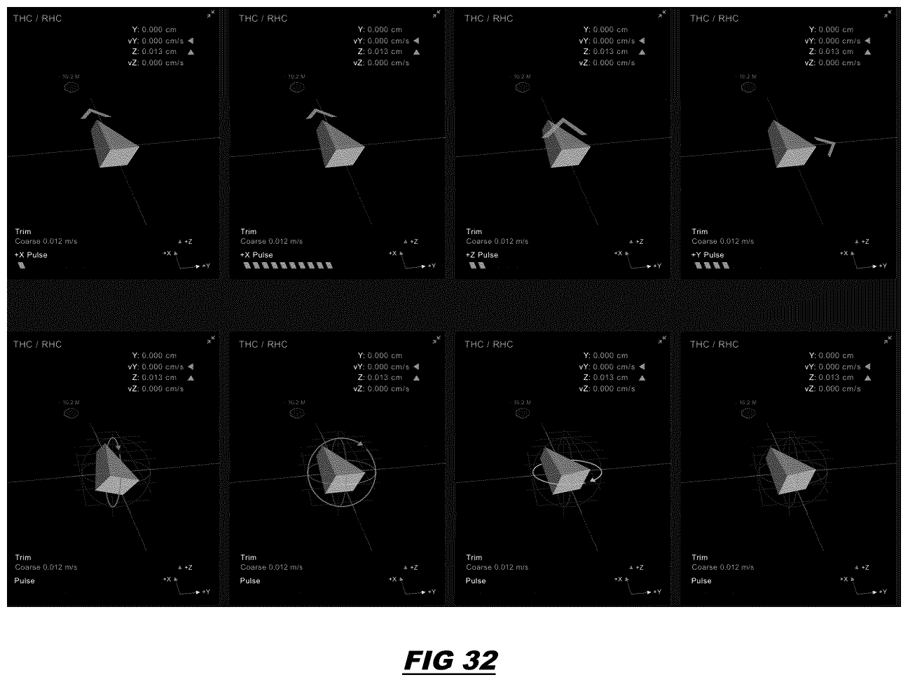

FIG. 32 illustrates a series of display screens indication pilot inputs over time to indicate multi-pulse commands. In this example, each time the pilot inputs a translation pulse command, the pulse is displayed in a progressive bar in the bottom left. The display system 120 may be configured to update the display 108 such that consecutive or multi-pulse commands can be visually indicated to the pilot.

Various terms are used throughout and for completeness, various definitions are included herein:
Breakout—A rendezvous maneuver on the chaser designed to quickly establish an opening rate between the chaser and target in order to prevent a potential collision.
Chaser—During rendezvous, the vehicle that is actively maneuvering to close the distance to and safely interface (e.g., dock) with a target vehicle.
Target—The vehicle to which the chaser is attempting to rendezvous. The target typically maintains the same state throughout the rendezvous.

Further, various methods for Rendezvous and Proximity Operations (RPO) Targeting for Near Rectilinear Halo Orbit (NRHO) rendezvous may be appreciated. For example, linearized Relative Targeting (LRT) may be used from [1] to perform discrete point-to-point maneuvers during rendezvous. This method uses linearized equations of motion from the rotating Earth-Moon system. This linearization yields a state transition matrix that is used to determine the change in velocity required to achieve a desired relative position after a specified transfer time. Each of the targeted maneuvers is specified in the mission plan that is included as a parameter of the RPOD Guidance subsystem. Current designs may include a rendezvous trajectory that determines the mission plan, which defines, for all RPOD maneuvers, the ignition time, transfer time, and position target for the Crew Lander relative to Gateway. Where greater targeting accuracy is required, a shooting method is deployed to iterate over successive executions of LRT to converge on an accurate targeting solution.

Proximity Guidance uses a discrete-time Linear Quadratic Regulator (LQR) to compute Delta-V. LQR minimizes a cost function that has contributions due to error between the measured state and the desired relative state as well as the output to control (i.e., Delta-V command). The desired relative state is set such that the vehicle is driven to track a reference velocity profile to initial contact. At each time step, the LQR feedback gain matrix is computed and is used to compute a Delta-V command. This Delta-V is provided as output to control.

The proposed LQR strategy is developed in two different varieties, to accommodate two different RPOD objectives:

Station keeping: The objective is to maintain a specified position at zero velocity.

Approach: The objective is to approach a specified point along a specified axis with a specified speed. The guidance law must regulate the speed along the approach axis with disregard to position along the approach axes, but must regulate off-axis position errors to zero.

RPO trajectory monitoring algorithms for NRHO rendezvous-Linear relative state constraints are used to define regions in space within which the chaser vehicle must remain in order to guarantee a safe rendezvous. Linear thresholds define trajectory position and velocity constraints, which are parameterized to define multiple sequential regions about the nominal rendezvous trajectory. These regions overlap to ensure transitions without gaps. When the chaser is determined to have departed from the constraint region, a breakout maneuver is automatically executed. Analysis to propagate the polytopes that defines the constraints regions through a breakout maneuver to guarantee that any breakout maintains safety with respect to the target vehicle is to be performed.

### Manual Control Algorithms for Lunar Descent and Landing.

Rate Command Attitude Hold (RCAH)—RCAH maps pilot Rotational Hand Controller (RHC) stick inputs to body rate commands. Stick inputs are converted from normalized values to rate commands. Algorithm parameters determine how the stick inputs are shaped into rate commands. RCAH handles commands in two channels: body roll (pilot yaw), and body pitch/yaw (pilot pitch/roll). For each channel, the vehicle maneuvers when the corresponding body rate or stick deflection is above a specified parameter threshold. When maneuvering, the pilot-axis attitude rate commands are determined by pilot RHC stick inputs. When the vehicle is no longer actively maneuvering, the attitude hold mode is engaged. In attitude hold mode, the body rate command is set to zero.

Incremental Rate of Descent (ROD)—Incremental ROD enables the pilot to manually command the vertical speed of the lander. On the first time-step in which manual control is active, the manual ROD command is initialized to the current reference ROD from Auto Guidance. For each positive Translational Hand Controller (THC) input, the manual rate of descent command is increased by a parameterized value. For each negative THC input, the manual rate of descent command is decreased by a parameterized value. The pilot may only make one ROD input at a time and must return the THC to detent before providing another input.

Manual Control Submodes—Three Manual Control submodes are used to manage transitions into Hover Hold (HH) and Incremental Position Command (IPC) modes while in manual control. The three submodes are Guidance Rate of Descent Only (GRDO), Guidance Null Lateral Velocity (GNLV), and Guidance Control Lateral Position (GCLP).

GRDO: GRDO is the default submode and allows the pilot to command the desired ROD and attitude rate of the Lander using the RHC and THC.

GNLV: When the lateral speed of the Crew Lander decreases below a specified threshold, the pilot has the option to enter GNLV, which implements HH. When the lander horizontal speed is below the lateral speed threshold is reached and the pilot engages GNLV, the control system automatically provides commands to null the lateral speed. The pilot continues to control rate of descent using Incremental ROD. If the Crew Lander lateral speed increases above the lateral speed threshold, Manual Control modes back to GRDO. The pilot may exit back to GRDO at any time by deflecting the RHC past the deadband.

GCLP: When in GNLV and once the lateral speed decreases below a separate, smaller lateral speed threshold, GCLP is automatically engaged, which implements IPC. At transition from GNLV to GCLP, a snapshot of the current horizontal position is taken and used as a reference for incremental lateral position commands. When in GCLP, the pilot may command changes in the lateral position from this reference. The pilot may provide positive or negative inputs along forward/back and left/right directions. The command directions are all relative to the Crew Lander pilot frame. The pilot may command multiple increments in the forward/back and left/right directions simultaneously. Manual Control provides commands to automatically achieve the desired change in position and then nulls the lateral speed at that position. If the Crew Lander lateral speed increases above a threshold, Manual Control modes back to GRDO. The pilot may exit back to GRDO at any time by deflecting the RHC past the deadband.

Manual control algorithms for NRHO RPO-During RPOD Final Approach, the Manual Control subsystem provides the pilot with several options for translational and rotational control. Translational control features incremental rate control, which translates discrete command stick inputs from the THC into a velocity command increment or decrement for each axis. The commands are incremented in the pilot's frame of reference. Furthermore, the increment size of the commands can be toggled to increase by the parameterized fine or coarse increment. By default, rotational control is maintained automatically using planar alignment between the docking ports, but can be set to manual by toggling the rotational mode option. In the incremental rate control manual mode, the RHC discrete inputs produce an angular rate increment and decrement about each axis in the pilot's frame of reference. For automatic rotational control modes, one option maintains line-of-sight (LOS) between the chaser and target vehicle docking ports. The other automatic mode maintains planar alignment the entire time while selected and it aims to align the docking ports so that there is no angular error between them. The planar alignment technique produces only translational motion when THC inputs are provided, whereas the LOS guidance will result in a rotational component with each translational input to maintain LOS.

### Acronyms

AC Approach Corridor
AFL Above Field Level
AS Approach Sphere
FTG Fuel To Go
GUI Graphical User Interface
HDOT Inertial Vertical Speed
HM Hazard Map
HNAV Horizontal Navigation Situation Display
HSD Horizontal Situation Display
HUD Head-up Guidance Display
IPC Incremental Position Command
IRSIS International Rendezvous System Interoperability Standards
KOS Keep-Out Sphere
LEO Low-Earth Orbit
LLO Low-Lunar Orbit
LT Landing Target
LVLH Local Vertical-Local Horizontal
NRHO Nearly Rectilinear Halo Orbit
NLV Null Lateral Velocity
PFD Primary Flight Display
RA Radar Altitude
RCAH Rate Command Attitude Hold
RHC Rotation Hand Controller
RPOD Rendezvous Proximity Operations and Docking
SI International System of Units
SLD Sustained Lunar Development
TBD To Be Determined
THC Translation Hand Controller
TTG Time To Go
VNAV Vertical Navigation Situation Display
YPR Yaw, Pitch, and Roll

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A display system for a vehicle, comprising:
a display configured to present a dynamic horizontal situation display;
a processor programmed to
receive vehicle data from at least one vehicle sensor, the vehicle data indicating at least one of roll, pitch, and yaw of the vehicle,
present, via the display, at least one ownship cue symbol overlaid on the horizontal situation display, and
dynamically update the at least one ownship cue symbol based on at least one of the roll, pitch, and yaw of the vehicle based on the vehicle data to provide visual aids regarding the roll, pitch, and yaw to a pilot.

2. The system of claim 1, wherein the ownship cue includes at least one leg having a leg length, wherein the leg length indicates at least one of the roll and pitch.

3. The system of claim 2, wherein the at least one leg dynamically rotates according to the yaw.

4. The system of claim 1, wherein the ownship cue includes a window symbol arranged within the ownship cue to represent at least one of the pitch and yaw.

5. The system of claim 1, wherein the processor is further programmed to receive location data of a target from at least one environmental sensor
present, via the display, a warning arc cue overlaid on the horizontal situation display, wherein the warning arc cue forms a semi-circle surrounding the target to provide trajectory feedback to the pilot.

6. A display system for a vehicle, comprising:
a display configured to present a dynamic aviation display;
at least one user interface configured to receive pilot commands;
a processor programmed to
receive at least one command from the user interface,
determine if a second and subsequent same command was received, and
update the display to visually indicate a pulse sequence in response to receiving a second same command.

7. The display system of claim 6, wherein the pulse sequence is indicated by an arrow on an XYZ grid, the arrow corresponding to the direction of the command.

8. The display system of claim 6, wherein the pulse sequence is indicated by a text, the text indicating a number of second same commands.

9. The display of claim 6, wherein the pulse sequence is indicated by a progressive bar, the bar increasing in length based on a number of the second same commands.

10. A method for generating a display for a vehicle, comprising:
receiving vehicle data from at least one vehicle sensor, the vehicle data indicating at least one of roll, pitch, and yaw of the vehicle,
present, via a display, at least one ownship cue symbol overlaid on the horizontal situation display, and
dynamically update the at least one ownship cue symbol based on at least one of the roll, pitch, and yaw of the vehicle based on the vehicle data to provide visual aids regarding the roll, pitch, and yaw to a pilot.

11. The method of claim 10, wherein the ownship cue includes at least one leg having a leg length, wherein the leg length indicates at least one of the roll and pitch.

12. The method of claim 11, wherein the at least one leg dynamically rotate according to the yaw.

13. The method of claim 10, wherein the ownship cue includes a window symbol arranged within the ownship cue to represent at least one of the pitch and yaw.

14. The method of claim 10, further comprising receiving location data of a target from at least one environmental sensor; and
presenting, via the display, a warning arc cue overlaid on the horizontal situation display, wherein the warning arc cue forms a semi-circle surrounding the target to provide trajectory feedback to the pilot.
